(19) United States
(12) Patent Application Publication
(10) Pub. No.: US 2024/0095513 A1
(43) Pub. Date: Mar. 21, 2024

(54) FEDERATED LEARNING SURROGATION WITH TRUSTED SERVER

(71) Applicant: QUALCOMM Incorporated, San Diego, CA (US)

(72) Inventors: Jian SHEN, San Diego, CA (US); Jamie Menjay LIN, San Diego, CA (US)

(21) Appl. No.: 17/932,809

(22) Filed: Sep. 16, 2022

(51) Int. Cl. G06N 3/08

(52) U.S. Cl. CPC G06N 3/08

(57) ABSTRACT

Certain aspects of the present disclosure provide techniques and apparatus for surrogated federated learning. A set of intermediate activations is received at a trusted server from a node device, where the node device generated the set of intermediate activations using a first set of layers of a neural network. One or more weights associated with a second set of layers of the neural network are refined using the set of intermediate activations, and one or more weight updates corresponding to the refined one or more weights are transmitted to a federated learning system.

### INTRODUCTION

Aspects of the present disclosure relate to efficient federated learning.

Federated learning involves training machine learning models across multiple decentralized devices, each holding local user data samples, without exchanging the data samples themselves. This enables multiple agents to collectively build a common and robust model using a wide variety of data samples from a wide variety of agents without exposing the training data itself. To do so, in conventional federated learning approaches, each participating agent uses its local training data to train or refine the model locally, and the weight updates are pooled and used by a central federated learning agent to generate an updated global model. This allows enhanced data privacy and data security while protecting data access rights, all while enabling training using heterogeneous data from multiple agents.

However, in conventional federated learning, the majority of the training burden falls on the participating node devices. That is, each individual agent is required to train and refine a local copy of the model, which requires substantial computational resources. In this way, conventional approaches to federated learning are often constrained by the characteristics of participating devices, especially if the devices are constrained with respect to power or computing resources (e.g., in the case of Internet of Things (IoT) devices, edge processing devices, always-on devices, wearables, mobile phones, and the like).

Accordingly, techniques are needed for improved federated learning.

### BRIEF SUMMARY

One aspect provides a method, comprising: receiving a set of intermediate activations at a trusted server from a node device, wherein the node device generated the set of intermediate activations using a first set of layers of a neural network; refining one or more weights associated with a second set of layers of the neural network using the set of intermediate activations; and transmitting one or more weight updates corresponding to the refined one or more weights to a federated learning system.

Another aspect provides a method, comprising: receiving, at a node device, at least a first set of layers of a neural network from a federated learning system; processing local data using the first set of layers to generate a set of intermediate activations; and transmitting the set of intermediate activations to a trusted server.

Other aspects provide processing systems configured to perform the aforementioned method as well as those described herein; non-transitory, computer-readable media comprising instructions that, when executed by a processor of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example workflow for surrogation in federated learning.

FIG. 2 depicts an example workflow for use of a trusted server to enable surrogation in federated learning.

FIG. 3 depicts an example flow diagram illustrating a method for surrogating federated learning at a node device.

FIG. 4 depicts an example flow diagram illustrating a method for surrogating federated learning using a trusted server.

FIG. 5 depicts an example flow diagram illustrating a method for machine learning using federated learning surrogation.

FIG. 6 depicts an example flow diagram illustrating a method for participating in surrogated federated learning.

FIG. 7 depicts an example processing system configured to perform various aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for improved federated learning via surrogation, such as via a trusted server.

In various aspects described herein, node devices participating in a federated learning process can receive a machine learning model (which is in the process of being trained) from a centralized federated learning system. Each node can then instantiate and use a portion of the model (e.g., the first P layers of a neural network, from the input layer up to a branch point) to generate a set of intermediate activations based on one or more local training samples. In an aspect, these intermediate activations can then be transmitted to one or more trusted servers or systems, which can then use the activations to refine one or more portions of the model.

In aspects of the present disclosure, the trusted server(s) or system(s) may be referred to as “trusted” by the node devices because the trusted entity enhances or protects user privacy in some way. For example, the trusted server may be implemented as an edge server on an enterprise premise (e.g., within the same enterprise as the node), as a dedicated server (e.g., one that is not co-hosting other applications, or one that has a private firewalled partition), or on the server of a trusted third party (which may have limited context, or no context, of the overall training other than the specific compute the third-party server is surrogated to perform).

As used herein, the term “branch point” refers to the point in the model in which a node device stops processing model elements (e.g., model layers) and the remaining model elements are “branched off” to the one or more trusted servers or systems.

For example, if the branch point is after the P-th layer of a neural network (and, therefore, the intermediate activations correspond to the output of the P-th layer), then the trusted server may receive the activations from the processing of the first P layers from a node device and pass these activations through the remaining portion(s) of the model (e.g., from layer P+1 through to the output). Once a final model output is obtained, the trusted server may then use backpropagation to refine some or all of the parameters (e.g., weights and/or biases) of the model. After performing one or more rounds or epochs of such “surrogated” training (using intermediate activations from one or more node devices), the trusted server may provide corresponding weight updates (e.g., the updated weights themselves, the gradients that define how the weights should be updated/changed, and the like) to a federated learning control element, such as a federated learning server or service, which can in turn use the weight updates (along with other weights and/or gradients from other nodes and/or trusted servers, in some aspects) to refine the global model. This global model can then be redistributed for the next round of training.

In some aspects, the trusted server can freeze one or more portions of the model (e.g., the first P layers) during training, refining only the subsequent portion(s). In an aspect, the resulting models may nevertheless exhibit high accuracy, as the first layers generally learn low-level features, and are not as sensitive (as compared to later layers) to domain shifts among user data (which is a primary motivation for federated learning). Therefore, distributed or federated training of those first P layers may not necessarily help the overall model performance. In some aspects, however, the trusted server may nevertheless refine these earlier model portions (e.g., one or more of the first P layers) as well. The trusted server may then transmit the weight updates to the federated learning control element, and/or distribute the weights and/or gradients to the nodes, allowing the nodes to update their local copies of the model.

Advantageously, in aspects of the present disclosure, the node devices may only process local data using the model (or a subset of the model), rather than performing actual on-node training, which can involve, for example, computing losses, computing gradients based on these losses, and the like. This surrogated federated learning thus significantly reduces the computational burden on the nodes (e.g., requiring reduced computational time, reduced power consumption, reduced memory demands, and the like). This reduction in on-device processing complexity can beneficially enable a broader range of devices to participate in federated learning, including relatively low performance devices (e.g., devices with limited computational resources, or limited battery life, etc.) to engage in federated learning efficiently. Because more devices may participate in federated learning according to aspects described herein, the federated learning process may be improved in various ways, including improving the performance of the resulting model by exposing more node-level data sets to the federated training, improving the speed of training because more devices are participating in parallel, and the like.

### Example Workflow for Surrogation in Federated Learning

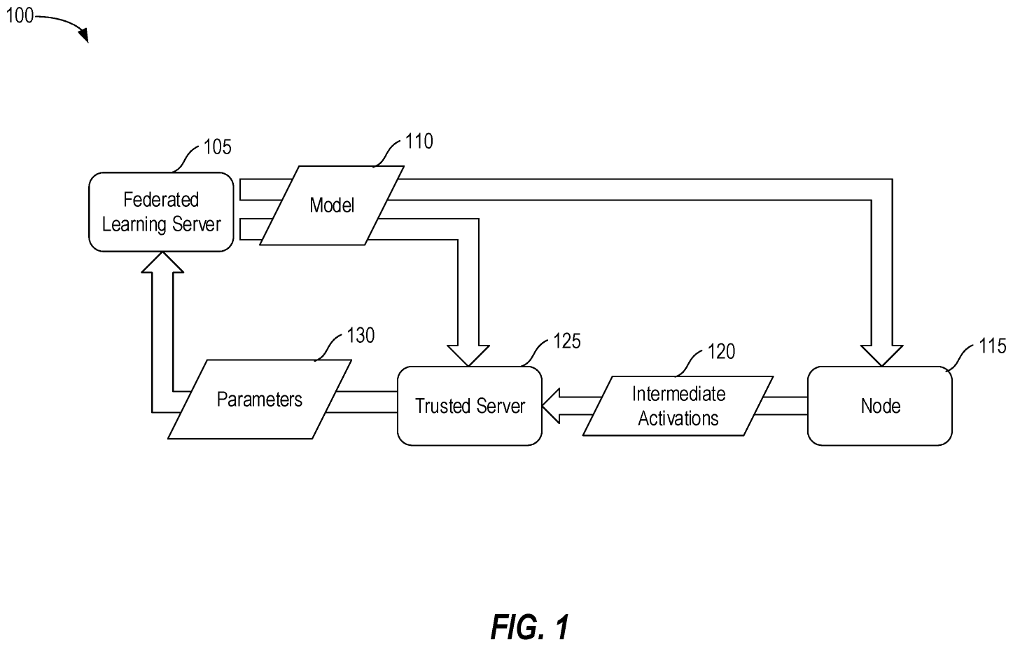

FIG. 1 depicts an example workflow 100 for surrogation in federated learning. In this context, surrogation refers to the sharing of training responsibility between one or more nodes and one or more trusted servers as compared to the conventional arrangement of a federated learning server interacting with nodes without a trusted server carrying some of the computational load.

As illustrated, a federated learning server 105 can distribute a model 110 to one or more trusted servers 125, as well as one or more participating nodes 115. Though the illustrated example depicts the federated learning server 105 distributing the model 110 directly to the node 115, in some aspects, the federated learning server 105 may instead distribute the model 110 to the trusted servers 125, which, in turn, can distribute the model to the node(s) 115 that use the trusted server 125 as a surrogate. Though a single trusted server 125 and node 115 are depicted for conceptual clarity in FIG. 1, there may be any number of trusted servers, each processing data on behalf of any number of nodes.

Generally, the federated learning server 105 receives model updates from participating entities, and uses the model updates to refine or update a global machine learning model. This updated global model can then be redistributed among participating entities, thereby initiating a subsequent round of training. Generally, the federated learning server 105, nodes 115, and trusted server 125 may each be implemented using hardware, software, or a combination of hardware and software. Further, although depicted as discrete components for conceptual clarity, in some aspects, some of the components (such as the federated learning server 105 and the trusted server 125) may be implemented as discrete components or as parts of one or more larger systems. For example, in one aspect, the federated learning server 105 and the trusted server 125 can operate on the same device, or as part of the same cloud service. In one such aspect, appropriate firewalling may be used to ensure that the intermediate activations remain private on the trusted server.

The model 110 is generally representative of a machine learning model and can correspond to any architecture, including neural networks, decision trees, and the like. In an aspect, the model 110 is generally associated with a set of one or more trainable parameters (e.g., weights and/or biases in a neural network) that are refined during the federated learning process.

In conventional federated learning systems, each participating node instantiates a local copy of the model and refines this local copy using local training data. For example, in the case of neural networks, each node passes training samples through the model (referred to as a forward pass) to generate an output inference. This inference can then be compared against ground-truth label(s) for the training sample(s) to compute a loss, and the loss can be used to refine the model parameters via backpropagation (referred to as a backward pass). In conventional systems, each node then transmits the updated parameters (or gradients) to the federated learning server, which pools or aggregates the updated parameters (or gradients) and updates the global model. The updated global model is then re-distributed, and the process is continued until some termination point.

As discussed above, these conventional approaches place the significant computational burden of training on the nodes, which limits which devices are able to participate in conventional federated learning. In aspects of the present disclosure, however, the trusted server(s) 125 can act as a surrogate for one or more nodes 115, enabling each to participate (using the node's own local data) using significantly reduced computational resources.

In the illustrated aspect, the node(s) 115 can process local training data using a defined portion of the model 110, such as the first P layers. In some aspects, the portion is defined based on a branch point, where layers prior to the branch are in the first portion (also referred to as the initial or input portion) and layers subsequent to the branch are in the second portion (also referred to as the subsequent portion, output portion, or final portion). For example, if the branch point is after layer P, then the first or initial portion includes layers 1 through P (or 0 through P, depending on whether zero-indexing is used), while the second or output portion includes layers P+1 through the final layer.

The output of the indicated layer (at the branch point) results in a set of intermediate activations that are typically internal to the model and would, in the conventional case, be processed using the subsequent portion of the model 110 to generate an output inference. In the illustrated example, however, these intermediate activations 120 are transmitted, from the node 115, to a trusted server 125.

In some aspects, the node 115 can refrain from processing these activations using the remaining portion(s) of the model 110. That is, the node 115 may refrain from generating an output inference, and use only the first portion to generate the activations. In at least one aspect, the node 115 may receive only the first portion of the model 110 (e.g., the first P layers). In some aspects, the node 115 may receive the entire model 110, but discard the second portion (e.g., from the P+1 layer through to the output layer), or otherwise refrain from using the second portion during the training phase (though the full model may be used during inferencing, after training is complete). In this way, as the node 115 may only perform a forward pass using a subset of the model 110 (and need not use the remaining layers or perform a backwards pass), the amount of resources of the node 115 that are called for can be substantially reduced.

Though not illustrated in the depicted example, in some aspects, the node 115 may first encrypt the intermediate activations 120 before transmitting the encrypted intermediate activations to the trusted server 125, as discussed below in more detail. In the illustrated example, the trusted server 125 receives the intermediate activations 120 (decrypting them if applicable) and uses the intermediate activations to generate a set of updated parameters 130 (or, in some implementations, gradients to update the parameters). As discussed above, though a single node 115 is depicted for conceptual clarity, in some aspects, the trusted server 125 may receive activations from multiple nodes 115. In such an aspect, the updated parameters 130 (or gradients) may be generated based on activations from multiple nodes. In at least one aspect, as discussed below in more detail, the trusted server 125 can selectively use or discard the activations from each node (e.g., by discarding activations that appear to be outliers).

In at least one aspect, to update the parameters 130, the trusted server 125 instantiates a local copy of the model 110 and processes each set of intermediate activations 120 using the defined second (or subsequent) portion(s) of the model 110. For example, if the intermediate activations 120 correspond to output from the P-th layer of the model 110, then the trusted server 125 may provide the intermediate activations as input to the P+1 layer (and on to subsequent layer(s)) to generate an output inference from the model 110.

In an aspect, the trusted server 125 can then compare the output inference(s) (generated based on the intermediate activations 120) with a ground-truth (provided by the node 115) in order to generate a loss, which can then be used to refine one or more parameters of the model 110. In one aspect, the trusted server 125 uses backpropagation to iteratively compute a set of gradients for refining the parameters of each layer of the model 110, beginning with the output layer and moving towards the input layer. In at least one aspect, the trusted server 125 refines only the layers that are subsequent to the branch point. That is, the first portion of the model 110 may remain fixed, while the subsequent portion is refined based on intermediate activations 120 from the node(s) 115.

In one such aspect, the first portion of the model 110 may be frozen, or may be trained separately (e.g., by the federated learning server 105). In at least one aspect, the first portion of the model is pre-trained (e.g., prior to the federated learning process is initiated). Alternatively, in some aspects, the trusted server 125 may refine the first portion of the model as well. For example, the trusted server 125 may compute gradients and/or updated parameters for the initial layers, and transmit these gradients and/or parameters to the federated learning server 105 and/or to the nodes 115 to update their local models.

In some aspects, the trusted server 125 can perform multiple training epochs using the set of intermediate activations 120. That is, the trusted server 125 may use the intermediate activations 120 to perform a first training epoch (e.g., using a first set of hyperparameters for the first epoch), and then use the same activations 120 again to perform a second (or subsequent) epoch (e.g., using a new set of hyperparameters or weights). Advantageously, if the first set of layers is fixed, then the trusted server 125 can perform multiple training epochs without needing any further input from the nodes 115.

In at least one aspect, if the trusted server 125 also updates the first portion of the model 110, then the trusted server can transmit the weight updates (e.g., the updated weights themselves, and/or the weight gradients) to the node(s) 115 after each epoch. Each node 115 can then use this updated model to generate a new set of intermediate activations 120, which are returned to the trusted server 125 for the next epoch.

Regardless of the particular methodology used by the trusted server 125, as illustrated, the trusted server 125 then returns a set of updated parameters 130 (or a set of gradients) to the federated learning server 105. As in conventional federated learning, the federated learning server 105 can then pool the parameters 130 received from each participating trusted server 125 and/or node 115, and update the global model. In some aspects, as discussed above, the federated learning server 105 keeps the initial portion of the model fixed during this update. In others, the federated learning server 105 may refine the initial portion of the model as well. This updated model 110 may then again be distributed to the trusted server(s) 125 and node(s) 115, enabling a subsequent round or iteration of training.

In some aspects, the branch point used in the workflow 100 can be derived in a number of ways, including through offline training and/or online training, or derived based on prior federated learning processes. In some aspects, the branch point is determined based on the computational cost of processing data at one or more layers of the model, the transmission cost of transmitting intermediate activations (e.g., 120) output by one or more layers, and training cost of updating the parameters of one or more layers, and/or the level of privacy associated with each set of activations from each layer. For example, the systems may use a cost function seeking to minimize the aggregated computational costs and transmission costs, while maximizing the privacy gains (e.g., where activations from subsequent layers of the model will tend to have higher privacy than earlier layers).

In at least one aspect, the branch point is determined using Equation 1 below, where P is the branch point, E is the number of training epochs (e.g., iterations of forward and backward passes) in the federated learning process, λ_{M}, λ_{A}, and λ_{W} are weight terms (discussed in more detail below, Mₗ is the computational cost of processing data using layer l, Aₗ is the transmission cost of transmitting activations output by layer l, Wₗ is the training (e.g., computational) cost of updating the parameters of layer l, and Gₗ is the level of privacy associated with keeping the activations output by layer l private and internal to the node (rather than transmitting the activations to the trusted server 125).

$$\\ P = {arg min}_{P} E * \{ {λ}_{M} {\sum }_{l = 1}^{P} {M}_{l} + {λ}_{A} {A}_{l , l = P} + {λ}_{W} {\sum }_{l = 1}^{P} {W}_{l} - {\sum }_{l = 1}^{P} {G}_{l} \}$$

Notably, as discussed above, if the node 115 does not itself perform parameter updating, then the Wₗ term may be omitted when seeking to minimize the burden on the node 115. Additionally, in some aspects, the trusted server 125 may perform multiple epochs of training using a single set of activations, as discussed above. In such an aspect, the E may also be omitted (or may be set based on the number of epochs for which the node will provide input). Generally, the computational expense of processing the data is related or proportional to P, such that a deeper branch point results in increased computational cost on the node. Additionally, the level of privacy is generally directly related or proportional to P, where deeper branch points result in increased privacy for the node. The transmission cost varies at least in part on the size of the output activations from each layer. In this way, the optimal branch point can be identified and used for the federated learning process.

In some aspects, the weight terms λ_{M}, λ_{A}, and λ_{W} can be defined or derived by one or more components of the workflow 100 (e.g., by the federated learning server 105, by the trusted server 125, and/or by the node 115) using offline training or online training, or may be otherwise defined (e.g., by an administrator) as hyperparameters for the surrogated training process.

In an aspect, after the federated learning process has completed, the node(s) 115 and/or trusted server 125 may receive a final copy of the global model. Each entity can then use these trained models for runtime inferencing. For example, the node 115 may process new data samples using the trained model to generate output inferences, and use these inferences for a variety of tasks (depending on the particular deployment). In some aspects, this surrogated federal learning may be particularly advantageous for nodes that are optimized or otherwise well suited for inferencing, but which cannot perform training as efficiently.

### Example Workflow for Surrogated Federated Learning

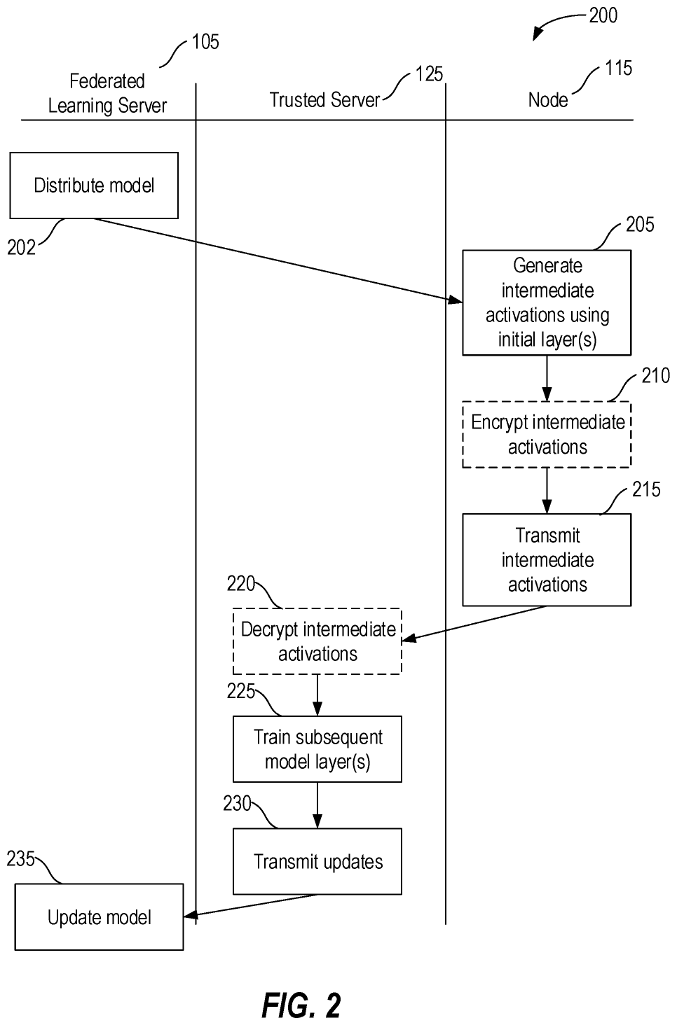

FIG. 2 depicts an example workflow 200 for use of a trusted server (e.g., 125 in FIG. 1) to enable surrogation in federated learning (e.g., in conjunction with a federated learning server 105 and/or node 115).

In the illustrated workflow 200, at block 202, the federated learning server 105 (e.g., the federated learning server 105 of FIG. 1) distributes the current version of the global model to the node(s) 115 (e.g., to the node 115 of FIG. 1). Although not included in the illustrated example, in some aspects, the federated learning server 105 can similarly distribute the current version of the model to the trusted server(s) 125.

At block 205, a node device (such as node 115 of FIG. 1) generates a set of intermediate activations using one or more initial layers of the received machine learning model (e.g., up to and/or through a branch point at or after layer P). In some aspects, as discussed above, the branch point is defined prior to beginning the federated learning workflow 200.

Generally, generating the intermediate activations can include processing one or more training samples as input to the model, and extracting the intermediate activations output by the layer immediately preceding the branch point. As discussed above, in some aspects, the node 115 can refrain from further processing of the intermediate activations. That is, the node 115 may refrain from using the intermediate activations as input to the next layer, thereby reducing computational expense on the node 115. In some aspects, block 205 may include generating a single set of intermediate activations (using a single data sample) or generating multiple intermediate activations (e.g., using multiple data samples). That is, the node 115 may process multiple input samples sequentially or in parallel to generate, for each respective input sample, a corresponding set of intermediate activations.

Generally, intermediate activations are considered to be more secure and private than the original input data. That is, given the intermediate activations, it may be difficult or impossible to derive the original input data. Additionally, in some aspects, intermediate activations from deeper layers in a model may generally be more secure or private than intermediate activations from earlier layers in the model (e.g., closer to the input layer). However, in some aspects, it may still nevertheless be possible to derive some original information from the activations.

In the illustrated example, at block 210, the node 115 optionally encrypts the set(s) of intermediate activations to further ensure privacy and data security. Generally, any suitable encryption method can be used, including as 1280-bit RSA public key encryption technique, a 128-bit AES encryption standard, signing the activations with ECDSA under a 256-bit NIST curve, and the like. In some aspects, the node 115 can use a transient session key (as opposed to a permanent encryption key), such that the intermediate activations are no longer able to be decrypted once training is complete.

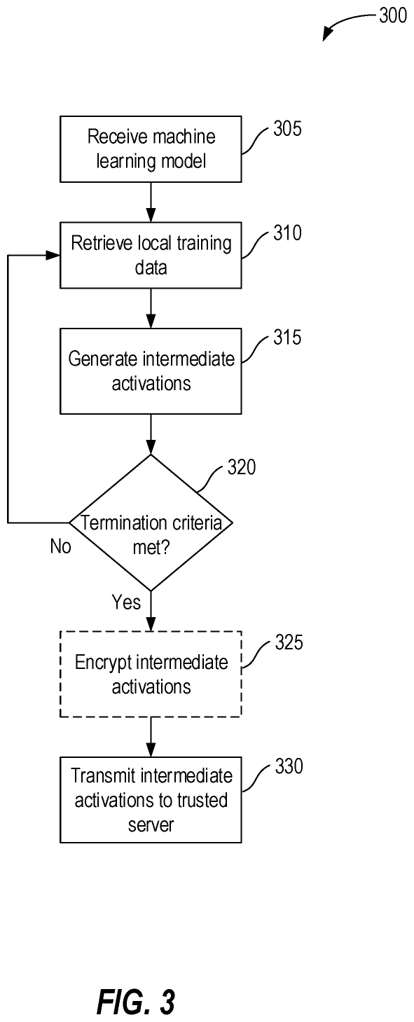

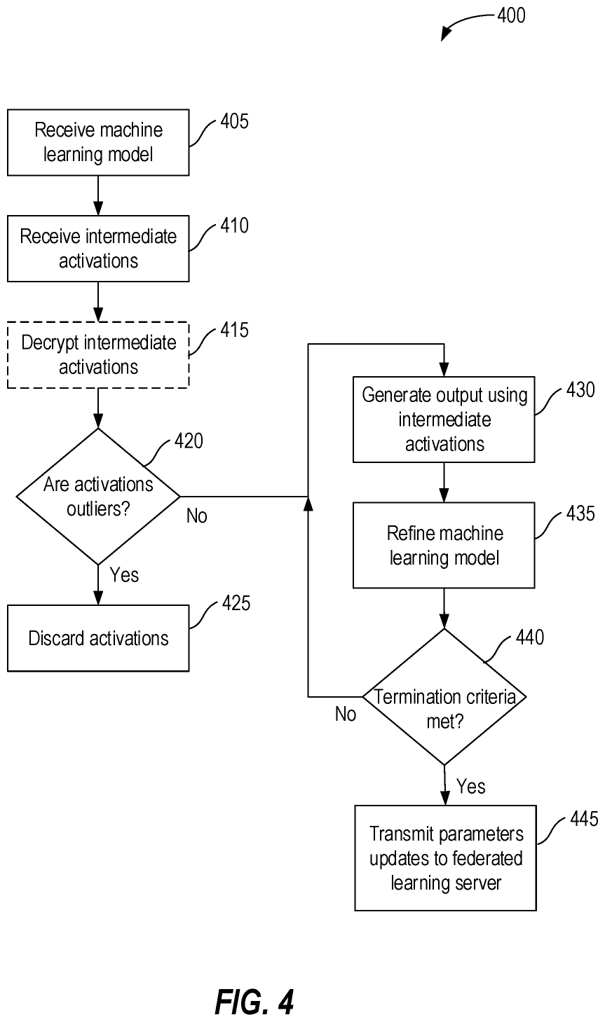

In some aspects of the present disclosure, dashed outlines are used to represent method steps which are optional, For example, blocks 210 and 220 may be considered optional. Similarly, block 325 of FIG. 3 and block 415 of FIG. 4 may be considered optional in some aspects.

At block 215, the node 115 transmits these (possibly encrypted) intermediate activations to a trusted server (such as the trusted server 125 of FIG. 1). Generally, transmitting the intermediate activations can include any suitable transmission technique and may include transmission over one or more networks, including wired networks, wireless networks, or a combination of wired and wireless networks. In at least one aspect, the node 115 transmits the intermediate activations using the Internet. Although not depicted in the illustrated example, in some aspects, the node 115 can additionally transmit an (optionally encrypted) ground truth label for each set of activations.

At block 220, the trusted server 125 optionally decrypts the intermediate activations (and labels, in some aspects).

At block 225, the trusted server 125 trains one or more subsequent layers of the model (e.g., the set of layers that begins after the branch point and continues through to the output of the model).

In some aspects, as discussed above, the trusted server 125 trains the subsequent portion of the model by processing each set of intermediate activations using the subsequent portion to generate an output inference. This output is then compared against the ground-truth label to generate a loss. The parameters of the subsequent portion of the model can then be refined based on the generated loss. In at least one aspect, as discussed above, the trusted server 125 trains only this subsequent portion of the model (e.g., after branch point at layer P), leaving the initial portion of the model fixed. In other aspects, the trusted server 125 may similarly refine the initial portion of the model.

After this phase of training (which may involve using one or more sets of activations from one or more nodes 115 during one or more epochs) is complete, at block 230, the trusted server 125 transmits the parameter updates, such as the trained parameters (e.g., weights and/or biases) and/or the gradients, to a federated learning server (e.g., the federated learning server 105 of FIG. 1). Though not included in the illustrated example, in some aspects, the trusted server 125 can encrypt the parameters and/or gradients prior to transmitting the encrypted parameters and/or gradients to the federated learning server 105.

At block 235, the federated learning server 105 aggregates the parameter updates (e.g., updated parameters and/or gradients) received from each participating trusted server 125 and/or node (if any node devices are using more conventional federated learning to update their own weights), and uses the aggregated updates to update the global model. Generally, if training is still ongoing, then the federated learning server 105 may then distribute this updated global model (e.g., to the trusted server(s) 125 and node(s) 115) to begin a new round of federated learning (e.g., using the same workflow 200 again).

### Example Method for Surrogating Federated Learning at a Node Device

FIG. 3 depicts an example flow diagram illustrating a method 300 for surrogating federated learning at a node device. In some aspects, the method 300 is performed by a node device, such as the node 115 of FIG. 1 and/or FIG. 2.

At block 305, the node receives a current version of a machine learning model being trained during a federated learning process. In aspects, this model may be received from a federated learning service (e.g., the federated learning server 105 of FIG. 1). In some aspects, receiving the machine learning model can include receiving the entire model or only a subset of the model. For example, the node may receive only the initial portion of the model (e.g., only through the branch point at layer P). This may reduce transmission expense of distributing the model, as well as reducing memory and storage demands on the node.

At block 310, the node retrieves one or more samples of local training data. As discussed above, the training data can generally include one or more samples (also referred to as exemplars), each with a corresponding label or ground-truth. In the illustrated example, the training data is referred to as “local” to indicate that this data is local to the node, in that the node need not (and does not) transmit the input exemplars to the federated learning system or the trusted server. Instead, these exemplars can remain secure and private on the node (or within a local network of the node).

At block 315, the node generates a set of intermediate activations based on a training exemplar. As discussed above, this may generally include processing the exemplar using one or more initial layers of a neural network model.

At block 320, the node determines whether one or more termination criteria are met. Generally, this termination criteria can include a wide variety of considerations, including determining whether any additional training exemplars remain to be processed, determining whether a defined number of exemplars have been evaluated (resulting in a defined number of intermediate activation sets), determining whether a defined amount of time has been spent, and the like. If the criteria are not satisfied, then the method 300 returns to block 310, where the node retrieves another training sample to generate another set of intermediate activations.

If, at block 320, the node determines that the termination criteria are satisfied, the method 300 continues to block 325, where the node can optionally encrypt the intermediate activations, as discussed above. Though the intermediate activations are generally more secure and private than the original training samples, encryption can nevertheless be used to further strengthen the data security of the surrogated federated learning.

At block 330, the node then transmits the (potentially encrypted) intermediate activations to the trusted server, as discussed above. In one aspect, the method 300 can be repeated any number of times by the node. For example, for each round of federated learning (e.g., each time the federated learning system distributes an updated global model), the method 300 may be used by each node to generate new activations for the round. These new activations can be generated using the same training data from previous rounds, using new training data, or using a mix of old and new data.

Although not depicted in the method 300 for conceptual clarity, in some aspects, the node can additionally receive the final global model once the federated learning process has completed. The node can then instantiate and use this model for runtime inferencing, as discussed above. In this way, the node is able to participate in and contribute to the federated learning process with reduced computational expense, enabling training of an improved global model that the node can use for future processing.

Note that FIG. 3 is just one example of a method, and other methods including fewer, additional, or alternative steps are possible consistent with this disclosure.

### Example Method for Surrogating Federated Learning using a Trusted Server

FIG. 4 depicts an example flow diagram illustrating a method 400 for surrogating federated learning using a trusted server. In some aspects, the method 400 is performed by a trusted server, such as the trusted server 125 of FIG. 1 and/or FIG. 2.

At block 405, the trusted server receives a current version of a machine learning model being trained using a federated learning process. In aspects, this model may be received from a federated learning system (e.g., the federated learning server 105 of FIG. 1). In some aspects, receiving the machine learning model can include receiving the entire model or only a subset of the model. For example, if the initial portion of the model is to remain fixed during the training, then the trusted server may receive only the subsequent portion of the model (e.g., only from the branch point at layer P through the output layer). This may reduce transmission expense of distributing the model, as well as reducing memory and storage demands on the trusted server.

At block 410, the trusted server receives one or more sets of intermediate activations from one or more nodes. As discussed above, these intermediate activations are generated, by each node, by processing local training data using the initial portion of the model.

At block 415, the trusted server can optionally decrypt the received activations, if the received activations are encrypted.

At block 420, the trusted server can optionally evaluate the received intermediate activations from each node to determine whether any are outliers. For example, if the trusted server receives intermediate activations from one or multiple nodes, then the trusted server can compare the intermediate activations across multiple nodes, compare statistics derived from the intermediate activations from multiple nodes, and/or compare the intermediate activations (or statistics) from one or more nodes with historical statistics or activations to determine whether any of the nodes sent an anomalous or outlier batch of activations. In conventional systems, outlier filtering can only be performed by the federated learning server (e.g., after the data has already been used by the node(s) to train the local models). Thus, by performing outlier detection at the trusted server (prior to using the activations to refine the model), the system is able to prevent wasted computing resources on outlier data. If any activations are determined to be outliers, in the illustrated example, the method 400 continues to block 425, where the trusted server optionally discards the outlier intermediate activations.

At block 420, for any activations that were determined to be not outliers (or if such outlier filtering is not used), the method 400 continues to block 430. At block 430, the trusted server generates a respective output inference for each respective set of (non-outlier) intermediate activations. For example, as discussed above, the trusted server may process each set of intermediate activations as input to the second portion of the machine learning model.

At block 435, the trusted server can then refine the machine learning model (which may include refining only a portion of the model) based on the generated output. For example, in one aspect, the trusted server may compare each generated output inference with a corresponding ground-truth (provided by the node) for the set of activations used to generate the inference. This allows the trusted server to generate a loss, which can be used to refine the model (e.g., via backpropagation). Generally, the model may be refined individually for each set of intermediate activations (e.g., using stochastic gradient descent) or based on batches of intermediate activations (e.g., using batch gradient descent).

In some aspects, as discussed above, refining the machine learning model comprises refining only a second, subsequent, or final portion of the model. For example, if the model is a neural network with L layers, then the activations may have been generated by the nodes using layers 1 to P, and the output can be generated by the trusted server using layers P+1 through L. The trusted server may then use backpropagation to refine the weights or biases of layers P+1 through L.

During this process, the first set of layers (e.g., from layer 1 through layer P) may be frozen or fixed. In other aspects, the trusted server may refine the first set of layers as well, as discussed above.

After the received set of intermediate activations have been used to refine the model, the method 400 continues to block 440. At block 440, the trusted server determines whether one or more termination criteria are satisfied. Generally, this termination criteria can include a wide variety of considerations, including determining whether any additional activations remain to be processed, determining whether a defined number of activations have been processed, determining whether a defined amount of time has been spent, and the like.

In some aspects, the criteria include determining whether one or more training epochs remain. That is, as discussed above, the trusted server may process all of the received intermediate activations as part of one training epoch, and then process the received intermediate activations again as part of a second (or subsequent) epoch.

If the criteria are not satisfied, the method 400 returns to block 430, where the trusted server generates one or more new output inferences by processing the received activations using the model. If the criteria are satisfied, then the method 400 continues to block 445.

At block 445, the trusted server transmits the parameter updates (e.g., updated weights and/or biases, gradients, and the like), determined at block 435, to the federated learning server. As discussed above, this may include parameter updates for a subset of the model (e.g., for the secondary, subsequent, or output layers), without any updates for the first or initial portion. As discussed above, the federated learning system can then pool or otherwise aggregate parameter updates to update the global model. As discussed above, transmitting the parameter updates can generally include transmitting the updated parameters themselves, as well as additionally or alternatively transmitting the gradients that were computed at block 435, allowing the federated learning system to pool these gradients (potentially averaged or aggregated using weighting) to update the global model.

Although not included in the illustrated example, in some aspects, as discussed above, the trusted server may refine the entire model at block 435 (rather than solely the second portion of the model). In one such aspect, the trusted server may transmit the weight updates to the node(s), allowing each to generate one or more new sets of activations.

Additionally, although not depicted in the method 400 for conceptual clarity, in some aspects, the trusted server can additionally receive the final global model once the federated learning process has completed. The trusted server can then instantiate and use this model for runtime inferencing, as discussed above. In this way, the trusted server is able to act as a surrogate for the node in the federated learning process, thereby reducing computational expense for the node, and enabling training of an improved global model that the trusted server and others can use for future processing.

Note that FIG. 4 is just one example of a method, and other methods including fewer, additional, or alternative steps are possible consistent with this disclosure.

### Example Method for Machine Learning Using Federated Learning Surrogation

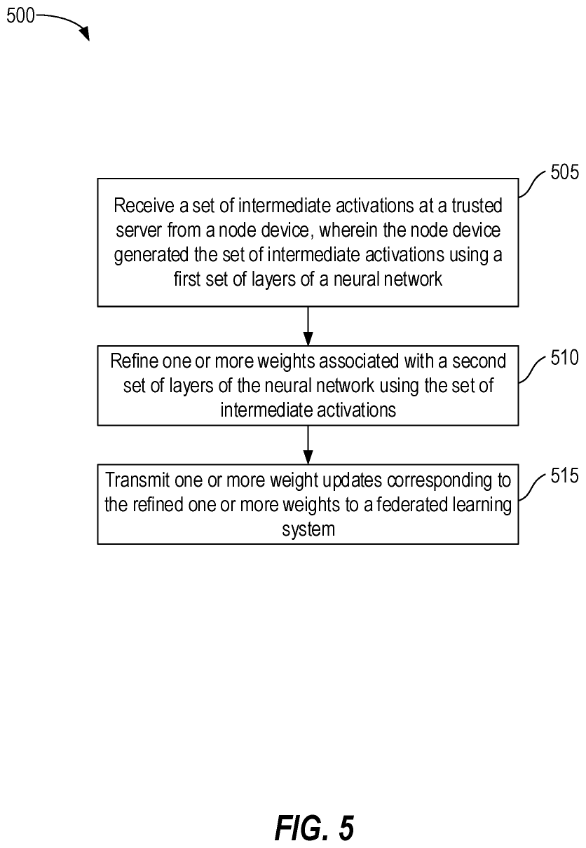

FIG. 5 depicts an example flow diagram illustrating a method 500 for machine learning using federated learning surrogation. In some aspects, the method 500 is performed by a trusted server, such as the trusted server 125 of FIG. 1.

At block 505, a set of intermediate activations are received at a trusted server from a node device, wherein the node device generated the set of intermediate activations using a first set of layers of a neural network.

At block 510, one or more weights associated with a second set of layers of the neural network are refined using the set of intermediate activations.

At block 515, one or more weight updates corresponding to the refined one or more weights are transmitted to a federated learning system.

In some aspects, the method 500 further comprises receiving, from the federated learning system, an updated version of the neural network, wherein the updated version of the neural network was generated based at least in part on the one or more weight updates.

In some aspects, the received set of intermediate activations is encrypted, and the method 500 further comprises, prior to refining the one or more weights, decrypting the set of intermediate activations.

In some aspects, the neural network comprises L layers, the first set of layers corresponds to an initial set of layers from layer 1 to layer P, and the second set of layers corresponds to a final set of layers from layer P+1 to layer L.

In some aspects, P was selected using a cost function based on one or more of: a computational cost of processing input data at each layer in the neural network, a transmission cost of transmitting intermediate activations associated with each layer in the neural network, or a level of privacy associated with the intermediate activations associated with each layer in the neural network.

In some aspects, the first set of layers is frozen while the second set of layers is refined.

In some aspects, refining the one or more weights associated with a second set of layers comprises performing a plurality of training epochs using the set of intermediate activations.

In some aspects, the method 500 further comprises: receiving a second set of intermediate activations from a second node device, determining that intermediate activations in the second set are outliers, and discarding the second set of intermediate activations.

Note that FIG. 5 is just one example of a method, and other methods including fewer, additional, or alternative steps are possible consistent with this disclosure.

### Example Method for Participating in Surrogated Federated Learning

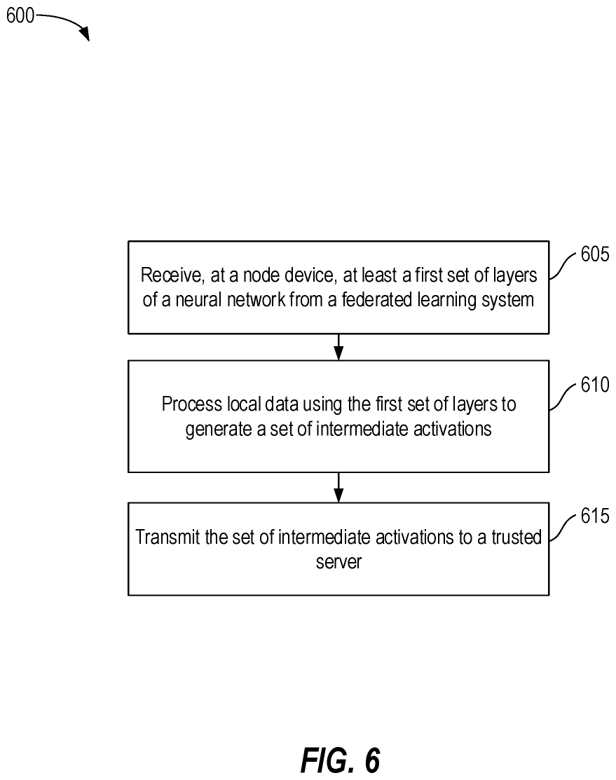

FIG. 6 depicts an example flow diagram illustrating a method 600 for participating in surrogated federated learning. In some aspects, the method 600 is performed by a node device, such as the node 115 of FIG. 1.

At block 605, at least a first set of layers of a neural network are received, at a node device, from a federated learning system.

At block 610, local data is processed using the first set of layers to generate a set of intermediate activations.

At block 615, the set of intermediate activations is transmitted to a trusted server.

In some aspects, the node device receives the neural network including the first set of layers and a second set of layers, and the node device uses only the first set of layers to generate the set of intermediate activations.

In some aspects, the method 600 further comprises: receiving, from a federated learning system, an updated version of the neural network, wherein the updated version of the neural network was generated based at least in part on the set of intermediate activations.

In some aspects, the method 600 further comprises: processing local data using a first set of layers of the updated version of the neural network to generate a new set of intermediate activations; and transmitting the new set of intermediate activations to the trusted server.

In some aspects, the method 600 further comprises processing local data using the updated version of the neural network to generate an inference.

In some aspects, the method 600 further comprises encrypting the set of intermediate activations prior to transmitting the encrypted set to the trusted server.

Note that FIG. 6 is just one example of a method, and other methods including fewer, additional, or alternative steps are possible consistent with this disclosure.

### Example Processing System for Surrogated Federated Learning

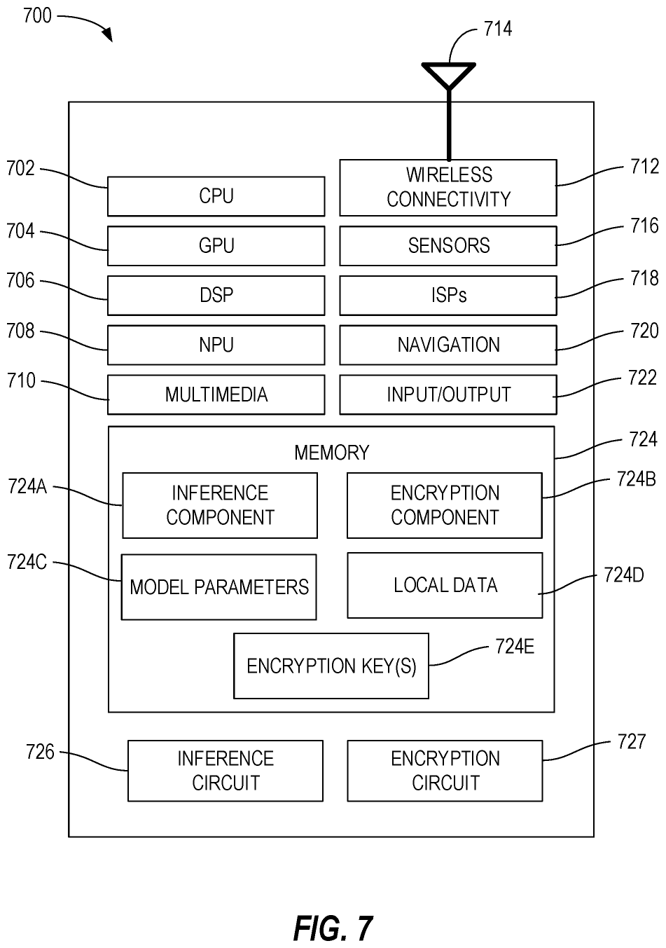

In some aspects, the workflows, techniques, and methods described with reference to FIGS. 1-6 may be implemented on one or more devices or systems. FIG. 7 depicts an example processing system 700 configured to perform various aspects of the present disclosure, including, for example, the techniques and methods described with respect to FIGS. 1-3 and 6. In one aspect, the processing system 700 may correspond to a node device participating in the federated learning, such as the node 115 of FIG. 1. In at least some aspects, as discussed above, the operations described below with respect to the processing system 700 may be distributed across any number of devices.

Processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., of memory 724).

Processing system 700 also includes additional processing components tailored to specific functions, such as a graphics processing unit (GPU) 704, a digital signal processor (DSP) 706, a neural processing unit (NPU) 708, a multimedia processing unit 710, and a wireless connectivity component 712.

An NPU, such as NPU 708, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece through an already trained model to generate a model output (e.g., an inference). In some aspects, the node devices are optimized for efficient inference, and may not be as efficient for training models. Thus, surrogation of the federated learning process via a trusted server can lead to significant improvements.

In one implementation, NPU 708 is a part of one or more of CPU 702, GPU 704, and/or DSP 706.

In some examples, wireless connectivity component 712 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 712 is further connected to one or more antennas 714.

Processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

Processing system 700 may also include one or more input and/or output devices 722, such as screens, touch-sensitive surfaces (including touch-sensitive displays), physical buttons, speakers, microphones, and the like.

In some examples, one or more of the processors of processing system 700 may be based on an ARM or RISC-V instruction set.

Processing system 700 also includes memory 724, which is representative of one or more static and/or dynamic memories, such as a dynamic random access memory, a flash-based static memory, and the like. In this example, memory 724 includes computer-executable components, which may be executed by one or more of the aforementioned processors of processing system 700.

In particular, in this example, memory 724 includes an inference component 724A and an encryption component 724B. The memory 724 also includes a set of model parameters 724C, local data 724D, and a set of one or more encryption key(s) 724E. The model parameters 724C may generally correspond to the parameters of all or a part of a machine learning model being trained using the federated learning process. The local data 724D generally corresponds to the local training data used by the node, and the encryption keys 724E may generally be used to encrypt the activations, if desired. The depicted components, and others not depicted, may be configured to perform various aspects of the techniques described herein. Though depicted as discrete components for conceptual clarity in FIG. 7, inference component 724A and encryption component 724B may be collectively or individually implemented in various aspects.

Processing system 700 further comprises inference circuit 726 and encryption circuit 727. The depicted circuits, and others not depicted, may be configured to perform various aspects of the techniques described herein.

For example, inference component 724A and inference circuit 726 may be used to generate intermediate activations during the training process, and/or to generate output inferences after the model is trained, as discussed above with reference to FIGS. 1-3 and/or 6. Encryption component 724B and encryption circuit 727 may be used to optionally encrypt the intermediate activations prior to transmitting the encrypted intermediate activations, as discussed above with reference to FIGS. 2, 3, and/or 6.

Though depicted as separate components and circuits for clarity in FIG. 7, inference circuit 726 and encryption circuit 727 may collectively or individually be implemented in other processing devices of processing system 700, such as within CPU 702, GPU 704, DSP 706, NPU 708, and the like.

Generally, processing system 700 and/or components thereof may be configured to perform the methods described herein.

Notably, in other aspects, aspects of processing system 700 may be omitted, such as where processing system 700 is a server computer or the like. For example, multimedia processing unit 710, wireless connectivity component 712, sensor processing units 716, ISPs 718, and/or navigation processor 720 may be omitted in other aspects. Further, aspects of processing system 700 maybe distributed between multiple devices.

### Example Processing System for Surrogated Federated Learning

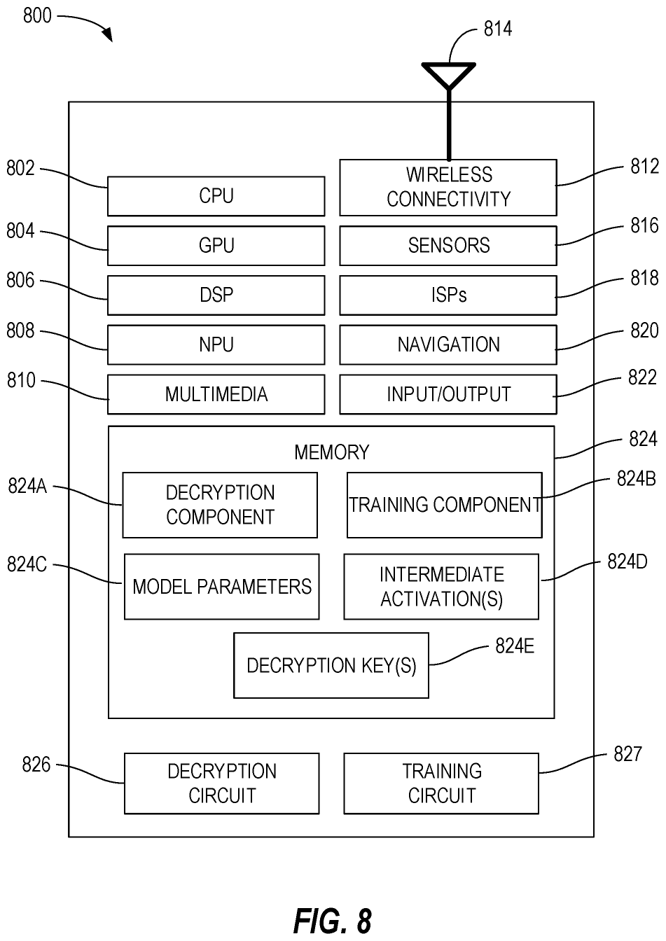

In some aspects, the workflows, techniques, and methods described with reference to FIGS. 1-6 may be implemented on one or more devices or systems. FIG. 8 depicts an example processing system 800 configured to perform various aspects of the present disclosure, including, for example, the techniques and methods described with respect to FIGS. 1, 2, and 4-5. In one aspect, the processing system 800 may correspond to a trusted server, such as the trusted server 125 of FIG. 1. In at least some aspects, as discussed above, the operations described below with respect to the processing system 800 may be distributed across any number of devices.

Processing system 800 generally includes a central processing unit (CPU) 802, a graphics processing unit (GPU) 804, a digital signal processor (DSP) 806, a neural processing unit (NPU) 808, a multimedia processing unit 810, a wireless connectivity component 812, one or more sensor processing units 816 associated with any manner of sensor, one or more image signal processors (ISPs) 818 associated with any manner of image sensor, a navigation processor 820, and one or more input and/or output devices 822. These components may generally be the same or similar to the corresponding components in FIG. 7.

Processing system 800 also includes memory 824, which is representative of one or more static and/or dynamic memories, such as a dynamic random access memory, a flash-based static memory, and the like. In this example, memory 824 includes computer-executable components, which may be executed by one or more of the aforementioned processors of processing system 800.

In particular, in this example, memory 824 includes a decryption component 824A and a training component 824B. The memory 824 also includes a set of model parameters 824C, intermediate activations 824D, and decryption keys 824E. The model parameters 824C may generally correspond to the parameters of all or a part of a machine learning model being trained using the federated learning process. The intermediate activations 824D may generally correspond to activations received from one or more nodes as part of a surrogated federated learning process, and the decryption keys 824E may be used to decrypt any encrypted activations (as appropriate). The depicted components, and others not depicted, may be configured to perform various aspects of the techniques described herein. Though depicted as discrete components for conceptual clarity in FIG. 8, decryption component 824A and training component 824B may be collectively or individually implemented in various aspects.

Processing system 800 further comprises decryption circuit 826 and training circuit 827. The depicted circuits, and others not depicted, may be configured to perform various aspects of the techniques described herein.

For example, decryption component 824A and decryption circuit 826 may be used to decrypt intermediate activations generated by node devices, as discussed above with reference to FIGS. 2, and/or 4-5. Training component 824B and training circuit 827 may be used to refine all or portions of the machine learning model based on these activations, as discussed above with reference to FIGS. 1-2 and/or 4-5.

Though depicted as separate components and circuits for clarity in FIG. 8, decryption circuit 826 and training circuit 827 may collectively or individually be implemented in other processing devices of processing system 800, such as within CPU 802, GPU 804, DSP 806, NPU 808, and the like.

Generally, processing system 800 and/or components thereof may be configured to perform the methods described herein.

Notably, in other aspects, aspects of processing system 800 may be omitted, such as where processing system 800 is a server computer or the like. For example, multimedia processing unit 810, wireless connectivity component 812, sensor processing units 816, ISPs 818, and/or navigation processor 820 may be omitted in other aspects. Further, aspects of processing system 800 maybe distributed between multiple devices.

### Example Clauses

Clause 1: A method, comprising: receiving a set of intermediate activations at a trusted server from a node device, wherein the node device generated the set of intermediate activations using a first set of layers of a neural network; refining one or more weights associated with a second set of layers of the neural network using the set of intermediate activations; and transmitting one or more weight updates corresponding to the refined one or more weights to a federated learning system.

Clause 2: The method according to Clause 1, further comprising receiving, from the federated learning system, an updated version of the neural network, wherein the updated version of the neural network was generated based at least in part on the one or more weight updates.

Clause 3: The method according to any one of Clauses 1-2, wherein the received set of intermediate activations is encrypted, the method further comprising, prior to refining the one or more weights, decrypting the set of intermediate activations.

Clause 4: The method according to any one of Clauses 1-3, wherein: the neural network comprises L layers, the first set of layers corresponds to an initial set of layers from layer 1 to layer P, and the second set of layers corresponds to a final set of layers from layer P+1 to layer L.

Clause 5: The method according to any one of Clauses 1-4, wherein P was selected using a cost function based on one or more of: a computational cost of processing input data at each layer in the neural network, a transmission cost of transmitting intermediate activations associated with each layer in the neural network, or a level of privacy associated with the intermediate activations associated with each layer in the neural network.

Clause 6: The method according to any one of Clauses 1-5, wherein the first set of layers is frozen while the second set of layers is refined.

Clause 7: The method according to any one of Clauses 1-6, wherein refining the one or more weights associated with the second set of layers comprises performing a plurality of training epochs using the set of intermediate activations.

Clause 8: The method according to any one of Clauses 1-7, further comprising: receiving a second set of intermediate activations from a second node device; determining that the second set of intermediate activations are outliers; and discarding the second set of intermediate activations.

Clause 9: A method, comprising: receiving, at a node device, at least a first set of layers of a neural network from a federated learning system; processing local data using the first set of layers to generate a set of intermediate activations; and transmitting the set of intermediate activations to a trusted server.

Clause 10: The method according to Clause 9, wherein: the node device receives the neural network including the first set of layers and a second set of layers, and the node device uses only the first set of layers to generate the set of intermediate activations.

Clause 11: The method according to any one of Clauses 9-10, further comprising receiving, from the federated learning system, an updated version of the neural network, wherein the updated version of the neural network was generated based at least in part on the set of intermediate activations.

Clause 12: The method according to any one of Clauses 9-11, further comprising: processing local data using the first set of layers of the updated version of the neural network to generate a new set of intermediate activations; and transmitting the new set of intermediate activations to the trusted server.

Clause 13: The method according to any one of Clauses 9-12, further comprising processing local data using the updated version of the neural network to generate an inference.

Clause 14: The method according to any one of Clauses 9-13, further comprising encrypting the set of intermediate activations prior to transmitting the set of intermediate activations to the trusted server.

Clause 15: A system, comprising: a memory comprising computer-executable instructions; and one or more processors configured to execute the computer-executable instructions and cause the processing system to perform a method in accordance with any one of Clauses 1-14.

Clause 16: A system, comprising means for performing a method in accordance with any one of Clauses 1-14.

Clause 17: A non-transitory computer-readable medium comprising computer-executable instructions that, when executed by one or more processors of a processing system, cause the processing system to perform a method in accordance with any one of Clauses 1-14.

Clause 18: A computer program product embodied on a computer-readable storage medium comprising code for performing a method in accordance with any one of Clauses 1-14.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, the term “connected to”, in the context of sharing electronic signals and data between the elements described herein, may generally mean in data communication between the respective elements that are connected to each other. In some cases, elements may be directly connected to each other, such as via one or more conductive traces, lines, or other conductive carriers capable of carrying signals and/or data between the respective elements that are directly connected to each other. In other cases, elements may be indirectly connected to each other, such as via one or more data busses or similar shared circuitry and/or integrated circuit elements for communicating signals and data between the respective elements that are indirectly connected to each other.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
receiving a set of intermediate activations at a trusted server from a node device, wherein the node device generated the set of intermediate activations using a first set of layers of a neural network;
refining one or more weights associated with a second set of layers of the neural network using the set of intermediate activations; and
transmitting one or more weight updates corresponding to the refined one or more weights to a federated learning system.

2. The processor-implemented method of claim 1, further comprising receiving, from the federated learning system, an updated version of the neural network, wherein the updated version of the neural network was generated based at least in part on the one or more weight updates.

3. The processor-implemented method of claim 1, wherein the received set of intermediate activations is encrypted, the method further comprising, prior to refining the one or more weights, decrypting the set of intermediate activations.

4. The processor-implemented method of claim 1, wherein:
the neural network comprises L layers,
the first set of layers corresponds to an initial set of layers from layer 1 to layer P, and
the second set of layers corresponds to a final set of layers from layer P+1 to layer L.

5. The processor-implemented method of claim 4, wherein P was selected using a cost function based on one or more of:
a computational cost of processing input data at each layer in the neural network,
a transmission cost of transmitting intermediate activations associated with each layer in the neural network, or
a level of privacy associated with the intermediate activations associated with each layer in the neural network.

6. The processor-implemented method of claim 1, wherein the first set of layers is frozen while the second set of layers is refined.

7. The processor-implemented method of claim 1, wherein refining the one or more weights associated with the second set of layers comprises performing a plurality of training epochs using the set of intermediate activations.

8. The processor-implemented method of claim 1, further comprising:
receiving a second set of intermediate activations from a second node device;
determining that the second set of intermediate activations are outliers; and
discarding the second set of intermediate activations.

9. A processor-implemented method, comprising:
receiving, at a node device, at least a first set of layers of a neural network from a federated learning system;
processing local data using the first set of layers to generate a set of intermediate activations; and
transmitting the set of intermediate activations to a trusted server.

10. The processor-implemented method of claim 9, wherein:
the node device receives the neural network including the first set of layers and a second set of layers, and
the node device uses only the first set of layers to generate the set of intermediate activations.

11. The processor-implemented method of claim 9, further comprising receiving, from the federated learning system, an updated version of the neural network, wherein the updated version of the neural network was generated based at least in part on the set of intermediate activations.

12. The processor-implemented method of claim 11, further comprising:
processing local data using the first set of layers of the updated version of the neural network to generate a new set of intermediate activations; and
transmitting the new set of intermediate activations to the trusted server.

13. The processor-implemented method of claim 11, further comprising processing local data using the updated version of the neural network to generate an inference.

14. The processor-implemented method of claim 9, further comprising encrypting the set of intermediate activations prior to transmitting the set of intermediate activations to the trusted server.

15. A system, comprising:
a memory comprising computer-executable instructions; and
a processor configured to execute the computer-executable instructions and cause the system to perform an operation comprising:
receiving a set of intermediate activations at a trusted server from a node device, wherein the node device generated the set of intermediate activations using a first set of layers of a neural network;
refining one or more weights associated with a second set of layers of the neural network using the set of intermediate activations; and
transmitting one or more weight updates corresponding to the refined one or more weights to a federated learning system.

16. The system of claim 15, the operation further comprising receiving, from the federated learning system, an updated version of the neural network, wherein the updated version of the neural network was generated based at least in part on the one or more weight updates.

17. The system of claim 15, wherein the received set of intermediate activations is encrypted, the operation further comprising, prior to refining the one or more weights, decrypting the set of intermediate activations.

18. The system of claim 15, wherein:
the neural network comprises L layers,
the first set of layers corresponds to an initial set of layers from layer 1 to layer P, and
the second set of layers corresponds to a final set of layers from layer P+1 to layer L.

19. The system of claim 18, wherein P was selected using a cost function based on one or more of:
a computational cost of processing input data at each layer in the neural network,
a transmission cost of transmitting intermediate activations associated with each layer in the neural network, or
a level of privacy associated with the intermediate activations associated with each layer in the neural network.

20. The system of claim 15, wherein the first set of layers is frozen while the second set of layers is refined.

21. The system of claim 15, wherein refining the one or more weights associated with the second set of layers comprises performing a plurality of training epochs using the set of intermediate activations.

22. The system of claim 15, the operation further comprising:
receiving a second set of intermediate activations from a second node device;
determining that the second set of intermediate activations are outliers; and
discarding the second set of intermediate activations.

23. One or more non-transitory computer-readable media comprising instructions that, when executed by one or more processors of a processing system, cause the processing system to perform an operation comprising:
receiving a set of intermediate activations at a trusted server from a node device, wherein the node device generated the set of intermediate activations using a first set of layers of a neural network;
refining one or more weights associated with a second set of layers of the neural network using the set of intermediate activations; and
transmitting one or more weight updates corresponding to the refined one or more weights to a federated learning system.

24. The one or more non-transitory computer-readable media of claim 23, the operation further comprising receiving, from the federated learning system, an updated version of the neural network, wherein the updated version of the neural network was generated based at least in part on the one or more weight updates.

25. The one or more non-transitory computer-readable media of claim 23, wherein the received set of intermediate activations is encrypted, the operation further comprising, prior to refining the one or more weights, decrypting the set of intermediate activations.

26. The one or more non-transitory computer-readable media of claim 23, wherein:
the neural network comprises L layers,
the first set of layers corresponds to an initial set of layers from layer 1 to layer P, and
the second set of layers corresponds to a final set of layers from layer P+1 to layer L.

27. The one or more non-transitory computer-readable media of claim 26, wherein P was selected using a cost function based on one or more of:
a computational cost of processing input data at each layer in the neural network,
a transmission cost of transmitting intermediate activations associated with each layer in the neural network, or
a level of privacy associated with the intermediate activations associated with each layer in the neural network.

28. The one or more non-transitory computer-readable media of claim 23, wherein the first set of layers is frozen while the second set of layers is refined.

29. The one or more non-transitory computer-readable media of claim 23, wherein refining the one or more weights associated with the second set of layers comprises performing a plurality of training epochs using the set of intermediate activations.

30. The one or more non-transitory computer-readable media of claim 23, the operation further comprising:
receiving a second set of intermediate activations from a second node device;
determining that the second set of intermediate activations are outliers; and
discarding the second set of intermediate activations.
